(19) United States
(12) Patent Application Publication
(10) Pub. No.: US 2010/0098409 A1
(43) Pub. Date: Apr. 22, 2010

(54) COMMUNICATION PATH SETTING METHOD, COMMUNICATION SYSTEM, OPTICAL PROPAGATION APPARATUS AND OPTICAL TRANSMISSION/RECEPTION DEVICE

(75) Inventors: Shigeaki Saito, Kawasaki (JP); Hajime Morikawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/581,450

(22) Filed: Oct. 19, 2009

(30) Foreign Application Priority Data
Oct. 20, 2008 (JP) 2008-269913

(51) Int. Cl. H04B 10/08

(52) U.S. Cl. 398/16

(57) ABSTRACT

An optical propagation apparatus and method setting a communication path to propagate a signal light between optical transmission/reception devices in different optical propagation apparatuses through a propagation path for multiplex communication. The optical propagation apparatus includes a conduction confirmation unit to confirm the conduction of the conduction confirming light output from one of the optical transmission/reception devices, and a setting unit to set, as a part of the communication path, the propagation path of the conduction confirming light following a point where the conduction of the conduction confirming light is confirmed by the conduction confirmation unit.

### CROSS-REFERENCE TO RELATED APPLICATIONS

This application is based upon and claims the benefit of priority of the prior Japanese Patent Application No. 2008-269913, filed on Oct. 20, 2008, the entire contents of which are incorporated herein by reference.

### BACKGROUND

1. Field

The embodiments discussed herein are related to a communication path setting method, a communication system, an optical propagation apparatus and an optical transmission/reception device.

2. Description of the Related Art

In a typical optical propagation apparatus, a communication path is set by connecting optical fibers to carry the signal. For example, the optical propagation apparatus accommodates an optical transmission/reception device, and the communication path is set between the optical transmission/reception devices accommodated in different optical propagation apparatuses. In this case, the communication path is set manually in all the optical propagation apparatuses through which the signal passes.

Setting the communication path is so complicated that a setting error is liable to occur and increase the time and cost required for setting. The worker, therefore, generally starts the job after fully being informed of the configuration of the optical propagation apparatus and the network.

The typical techniques are disclosed in Japanese Patent Application Laid-Open No. 08-331047 and Japanese Patent Application Laid-Open No. 2003-174432.

### SUMMARY

According to an aspect of the invention, an optical propagation apparatus is arranged on a communication system to set a communication path to propagate a signal light between optical transmission/reception devices in different optical propagation apparatuses, through a propagation path for multiplex communication where the optical propagation apparatuses accommodates each optical transmission/reception device and includes a conduction confirmation unit to confirm conduction of the conduction confirming light output from one of the optical transmission/reception devices, and a setting unit to set, as a part of the communication path, the propagation path of the conduction confirming light following a point where the conduction of the conduction confirming light is confirmed by the conduction confirmation unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed. Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram showing an optical propagation apparatus according to an embodiment;

FIG. 2 is a diagram showing an example of a conduction confirming light;

FIG. 3 is a diagram showing an example of a demultiplexer;

FIG. 4 is a diagram showing an example of a multiplexer;

FIG. 5 is a diagram showing an example of an optical switch;

FIG. 6 is a diagram showing an example of an OSC (optical supervisory channel) unit;

FIG. 7 is a diagram for explaining an example of setting a communication path between optical line cards (OLCs);

FIG. 8 is a flowchart for explaining an example of setting a communication path between OLCs; and

FIG. 9 is a flowchart for explaining another example of setting a communication path between OLCs.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

An object of this invention includes promoting automation of the job of setting the communication path. Another object of the invention is to shorten the time required for setting the communication path.

Still another object of the invention is to reduce the work load and suppress or reduce the occurrence of a setting error or the like.

The objects of the invention are not limited to the aforementioned ones and also include the exhibition of the effects obtained by the configuration or operation according to the best mode for carrying out the invention described later which cannot be obtained by the typical techniques.

Embodiments are explained below with reference to the drawings. The embodiments explained below, however, are illustrative after all and not intended to exclude the application of various modifications and techniques not expressly described below. In other words, these embodiments can be implemented in various modifications without departing from the spirit of the invention.

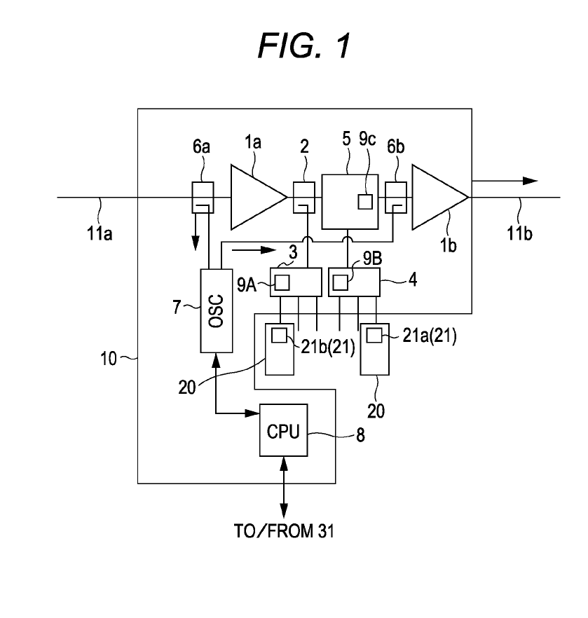

FIG. 1 is a diagram showing an optical propagation apparatus according to an embodiment. The optical propagation apparatus 10 shown in FIG. 1 is, for example, an OADM (optical add-drop multiplexer) node in a wavelength division multiplexing (WDM) propagation system. Specifically, the optical propagation apparatus 10 can be connected to other optical propagation apparatuses, not shown, through WDM optical propagation paths 11a, 11b as an example of the propagation path for multiplex communication.

Also, the optical propagation apparatus 10 can be connected to OLCs (optical line cards) 20 as an example of underlying optical transmission/reception devices. As a result, the communication path is set between the OLCs 20 accommodated in the optical propagation apparatuses 10 connected through the WDM optical propagation paths 11 (11a, 11b) and the communication between the OLCs is performed. In the process, the communication path for communication between the OLCs can be set by automated operation(s) as illustratively explained later.

The optical propagation apparatus 10 may include, as an example, optical amplifiers 1a, 1b, a divergence unit 2, a demultiplexer (DEMUX) 3, a multiplexer (MUX) 4, an optical switch 5, a signal light/control light separator 6a, a signal light/control light combiner 6b, an OSC (optical supervisory channel) unit 7 and a control unit 8.

In the signal light/control light separator 6a, the light input from the input-side WDM optical propagation path 11a is separated into, for example, the light of a wavelength assigned to the control light including the control information and the light of a wavelength assigned to the main signal light. A preamplifier is an example of the optical amplifier 1a and amplifies the light input from the input-side WDM optical propagation path 11a through the separator 6a.

The divergence unit 2 diverges the light amplified by the optical amplifier 1a, and guides one part of the light to the optical switch 5 and the other part of the light to the demultiplexer 3. The demultiplexer 3 demultiplexes the light from the divergence unit 2 into wavelength components (channels), so that the light having the wavelength corresponding to each channel thus separated can be guided to one of the OLCs 20 accommodated as an underlying device. The multiplexer 4, on the other hand, multiplexes the wavelength of the light corresponding to the channel from the underlying OLCs 20 and outputs it to the optical switch 5.

The demultiplexer 3, therefore, is an example of the demultiplexer for separating the signal light input from the propagation path into the light components corresponding to the respective channels, and the multiplexer 4 is an example of the multiplexer for multiplexing the light components corresponding to the respective channels from the underlying optical transmission/reception devices.

As a result, each OLC 20 connected to the demultiplexer 3 can receive the light (for example, a conduction confirming light and the signal light) from the WDN optical propagation path 11a. Each OLC 20 connected to the multiplexer 4, on the other hand, can transmit the light (for example, the conduction confirming light and the signal light) through the WDM optical propagation path 11b. Incidentally, the OLCs 20 connected to the demultiplexer 3 and the multiplexer 4, though shown as separate units in the drawing, may be packaged integrally for light transmission and reception.

In the optical switch 5, the light input from the WDM optical propagation path 11a and the light from the multiplexer 4 are selectively output for each channel (wavelength). Specifically, the light from the WDM optical propagation path 11a is input through the divergence unit 2 while at the same time inputting the light from the multiplexer 4, and the light output to the output-side WDM optical propagation path 11b is selectively switched for each channel.

In the signal light/control light combiner 6b, the light output from the optical switch 5 and the control light from the OSC unit 7 are combined with each other and output to the optical amplifier 1b. The postamplifier is an example of the optical amplifier 1b to amplify the light output from the combiner 6b to the output-side WDM optical propagation path 11b.

The OSC unit 7 executes the process based on the control information (monitor information) included in the control light from the demultiplexer 6a, and outputs the processing result to the control unit 8, while at the same time generating and outputting the control light including the control information to be transmitted through the output-side WDM optical propagation path 11b.

FIG. 6 is a diagram showing an example of the OSC unit 7. The OSC unit 7, as illustrated in FIG. 6, includes an O/E (optical/electrical) converter 7a, a control processing unit 7b and an E/O (electrical/optical) converter 7c.

The O/E converter 7a receives the control light containing the control information from another optical propagation apparatus as an adjacent station connected through the WDM optical propagation path 11a. The control processing unit 7b executes the process based on the control information contained in the control light from the O/E converter 7a and delivers the processing result to the control unit 8. Also, the control processing unit 7b outputs to the E/O converter 7c the control information to be propagated through the output-side WDM optical propagation path 11b. The E/O converter 7c generates the control light based on the processing result in the control processing unit 7b, and transmits the control light generated to the WDM optical propagation path 11b through the signal light/control light combiner 6b.

Also, in FIG. 1, the CPU (central processing unit) is an example of the control unit 8 and controls the operation of the optical propagation apparatus 10 including the setting and the management of the optical path for each channel in the optical propagation apparatus 10. The control unit 8 can also set and manage the output light wavelength for the underlying OLCs 20. While the control unit 8 is illustrated in FIG. 1 as being a CPU, the present invention is not limited to any particular type of unit, computer or device and the unit 8 may be any controller having a processor for executing operation(s) discussed herein including any dedicated apparatus or general computer.

Each OLC 20 accommodated in the optical propagation apparatus 10 is assigned one channel for WDM optical propagation by the optical propagation apparatus 10 accommodating the OLC 20. In the process, the communication path using the assigned channel is set with the OLC accommodated in other optical propagation apparatus thereby to realize the communication between the OLCs.

The OLC 20 includes a conduction confirming light transmission unit 21a for outputting (transmitting) the conduction confirming light propagated along the path to be set as the communication path described above and a conduction confirming light reception unit 21a for receiving the conduction confirming light. Incidentally, the conduction confirming light transmission unit 21a and the conduction confirming light reception unit 21a may be integrated as a conduction confirming light transmission/reception unit 21. The conduction confirmation light, for example, enables verification or confirmation of transmission/receipt of light to be performed.

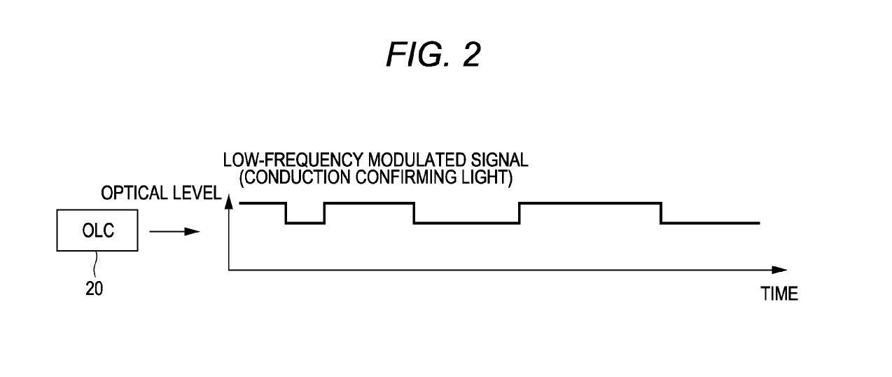

The conduction confirming light, by being propagated along the communication path to be set between the OLCs, can be used for confirming the conduction (transmission/receipt) along the path sequentially at midway points. For this purpose, the conduction confirming light, though having a light wavelength corresponding to the channel assigned to the communication path to be set, is discriminated from the signal light used in practical application for communication. The conduction confirming light output from the conduction confirming light transmission unit 21a (or input to the conduction confirming light reception unit 21a), for example, as illustrated as a level change on time axis in FIG. 2, can be the light having a fluctuation of a frequency sufficiently lower than the frequency equivalent to the bit rate of the main signal.

The optical propagation apparatus 10 shown in FIG. 1 includes an element for confirming the input of the conduction confirming light from the conduction confirming light transmission unit 21a of the OLC 20 at points midway of the communication path to be set as described above. The demultiplexer 3, the multiplexer 4 and the optical switch 5, for example, can include conduction confirmation units 9A to 9C, respectively, for confirming the conduction (transmission/reception) of the conduction confirming light output from the conduction confirming light transmission unit 21a described above.

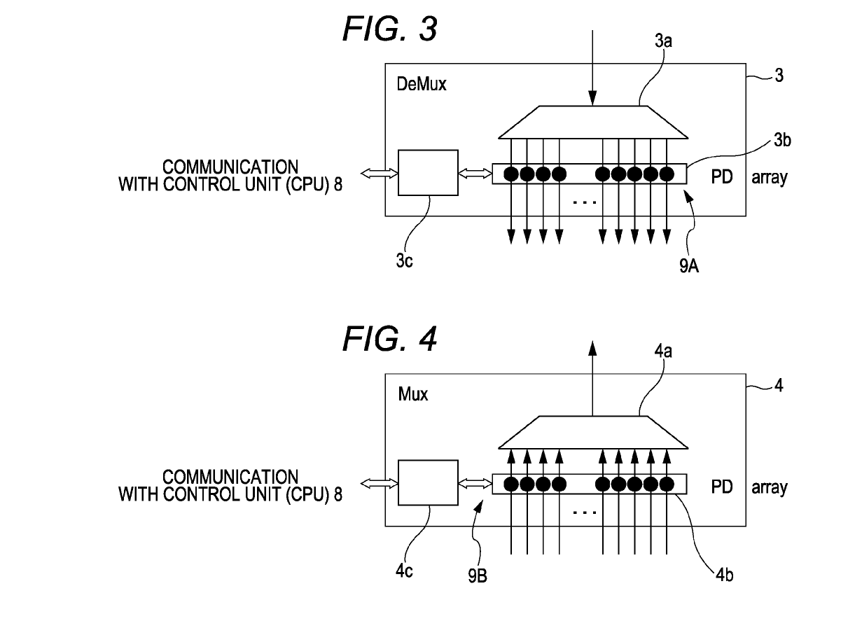

FIG. 3 is a diagram showing an example of the demultiplexer 3 including the conduction confirmation unit (second conduction confirmation unit) 9A. The demultiplexer 3, as illustrated in FIG. 3, includes a demultiplexer element 3a and the conduction confirmation unit 9A.

In the demultiplexer element 3a, the wavelength multiplexed light propagated through the WDM optical propagation path 11a is demultiplexed into the light for each channel from the divergence unit 2. An example of the demultiplex element 3a is an AWG (arrayed waveguide gratings). Incidentally, the element in wavelength multiplexing in the wavelength multiplexed light may be either the signal light modulated from the main signal for the channel in practical communication or the conduction confirming light for the channel in the process of setting the communication path. Also, the conduction confirmation unit 9A is arranged in the path of the wavelength demultiplexed light separated by the demultiplexer element 3a to confirm the conduction of the conduction confirming light for each channel. As illustrated in FIG. 3, the conduction confirmation unit 9A includes a PD (photodetector) array 3b and a confirmation processing unit 3c.

The PD array 3b has an array of PDs arranged to monitor an optical power of the wavelength demultiplexed light separated by the demultiplexer element 3a for each path and guided to the OLC 20. Each PD making up the PD array 3b obtains a response following the low-frequency component of the conduction confirming light.

In the confirmation processing unit 3c, the conduction of the conduction confirming light is confirmed, for each channel in wavelength multiplexing, based on a result of monitoring the optical power of the wavelength demultiplexed light from each PD of the PD array 3b. By extracting the aforementioned low-frequency component of each monitor signal from the PD array 3b, for example, the input of the conduction confirming light is confirmed.

The confirmation processing unit 3c, upon confirmation of the input of the conduction confirming light, outputs the result to the control unit 8. The control unit 8 can set an element (a part) of the communication path for the channel with the conduction confirming light input confirmed by the confirmation processing unit 3c.

FIG. 4 is a diagram showing an example of the multiplexer 4 including the conduction confirmation unit (third conduction confirmation unit) 9C. The multiplexer 4, as illustrated in FIG. 4, includes a multiplexer element 4a and a conduction confirmation unit 9C.

The multiplexer element 4a is input from the OLC 20 with the light having the wavelength corresponding to the assigned channel (the conduction confirming light for setting the path, and the signal light modulated from the main signal for practical application of communication) so that the light of the respective channels are bundled together by wavelength multiplexing.

As an example, the multiplexer element 4a includes as many input ports as channel(s) that can be accommodated as the optical propagation apparatus 10 and one output port whereby the light input to the input port is multiplexed and guided to the optical switch 5. In this case, by including the WSS (wavelength selective switch) as an element in the multiplexer element 4a, the light of the wavelength corresponding to an arbitrary channel assigned by setting the OLC 20, after being received at whichever input port position and wavelength-multiplexed, can be guided to the optical switch 5.

Also, the conduction confirmation unit 9C confirms, for each channel, the conduction of the conduction confirming light input to the multiplexer element 4a, and as shown in FIG. 4, includes a PD (photodetector) array 4b and a confirmation processing unit 4c.

The PD array 4b includes PDs arranged in array to monitor the optical power, for one path, of the light input to the multiplexer element 4a. Each PD making up the PD array 4b obtains the response following the low-frequency component in the conduction confirming light.

The conformation processing unit 4c, based on the result of monitoring the optical power of the light from each PD in the PD array 4b, executes the process of confirming the conduction of the conduction confirming light for each channel in wavelength multiplexing. By extracting the low-frequency component of each monitor signal from the PD array 4b, for example, the input of the conduction confirming light is confirmed.

The confirmation processing unit 4c, upon confirmation of the input of the conduction confirming light, outputs the fact to the control unit 8. The control unit 8 can set an element (a part) of the communication path for the channel with the conduction confirming light input confirmed by the confirmation processing unit 4c.

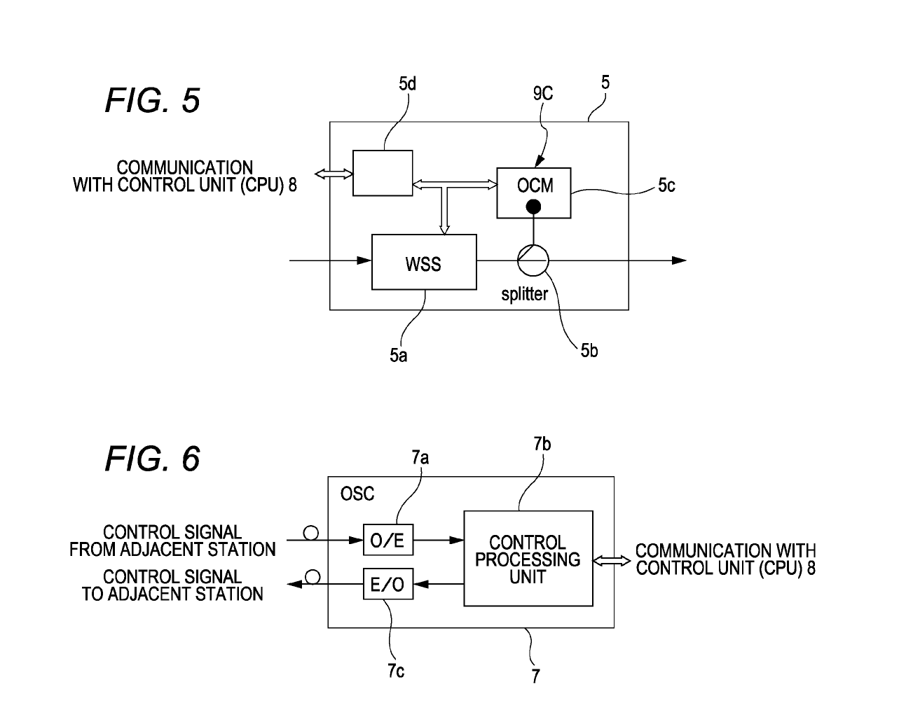

FIG. 5 is a diagram showing an example of the optical switch 5 including a conduction confirmation unit (first conduction confirmation unit) 9A. The optical switch 5, as illustrated in FIG. 5, includes a switch element 5a and the conduction confirmation unit 9A.

The switch element 5a, input with the light multiplexed by the multiplexer 4 together with the light propagated along the WDM optical propagation path 11a, switches, for each channel, the optical path guided by the WDM optical propagation path 11b. The WSS (wavelength selective switch) for selectively outputting the light of an arbitrary wavelength from an arbitrary input port to the port set as an output destination can be an example of the switch element 5a.

In the switch element 5a, therefore, the light of the first channel from the WDM optical propagation path 11a or the light of the first channel from the multiplexer 4, whichever has been propagated through the WDM optical propagation path 11a, can be output in the direction guided by the WDM propagation path 11b. Also, the light of the second channel from the multiplexer 4 different from the first channel can be output in the direction selectively led to the WDM optical propagation path 11b.

Also, the conduction confirmation unit 9A confirms, for each channel, the conduction of the conduction confirming light output from the switch element 5a, and include a splitter 5b, an OCM (optical channel monitor) 5c and a confirmation processing unit 5d.

The splitter 5b diverges the power of a part of the light (WDM light) output from the switch element 5a. In the OCM 5c, the power is monitored for each channel component in wavelength multiplexing for the light partly split in power by the splitter 5b. The confirmation processing unit 5d, based on the result of monitoring the optical power from the OCM 5c, confirms the conduction of the conduction confirming light for each channel in wavelength multiplexing. By extracting the low-frequency component of each monitor signal from the OCM 5c, for example, the input of the conduction confirming light is confirmed.

The confirmation processing unit 5d, upon confirmation of the input of the conduction confirming light, outputs the fact to the control unit 8. In the control unit 8, an element (a part) of the communication path can be set for the channel with the conduction confirming light input confirmed in the confirmation processing unit 5c.

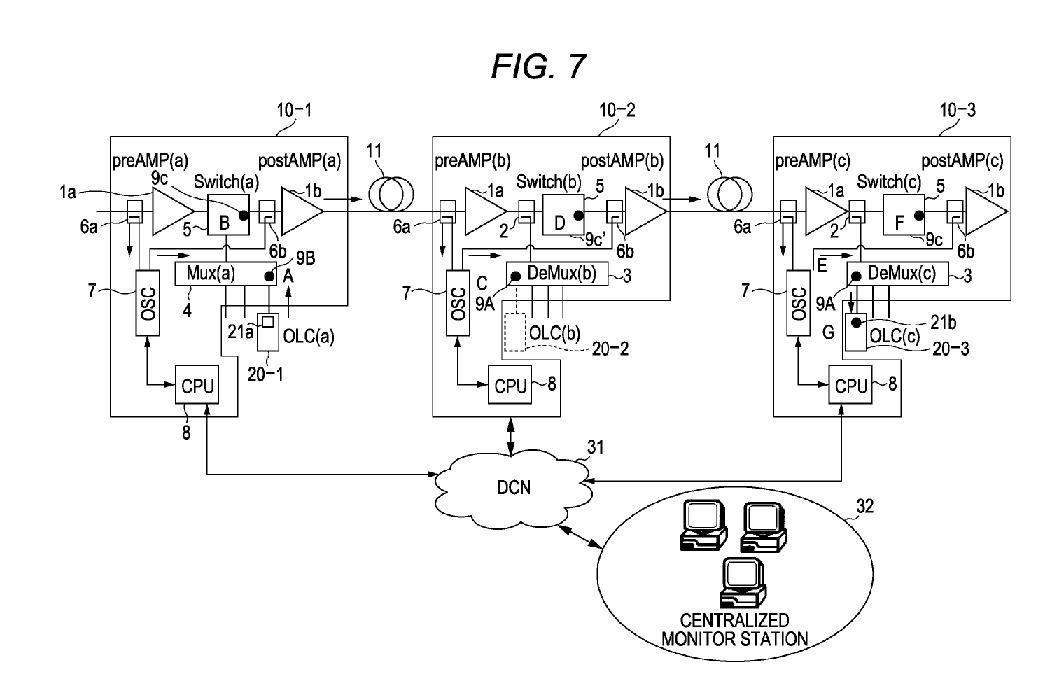

Assuming that an optical communication system is constructed of a plurality of the aforementioned optical propagation apparatuses 10 connected by the WDM optical propagation path 11, an explanation is given below about an example of setting a communication path between the OLCs as illustrated in FIG. 7.

Incidentally, in the optical communication system illustrated in FIG. 7, the three optical propagation apparatuses 10-1 to 10-3 are connected to each other through the WDM optical propagation path 11. Also, the optical propagation apparatuses 10-1 to 10-3 are each connected with an underlying OLC 20 along the communication path to be set.

In FIG. 7, the divergence unit 2 and the demultiplexer 4 of the optical propagation apparatus 10-1 and the multiplexer 3 of the optical propagation apparatuses 10-2, 10-3 are not shown. Also, a centralized monitor station 32 is connected, through a DCN (data communication network) 31, to each CPU as an example of the control unit 8 of each of the optical propagation apparatuses 10-1 to 10-3. As a result, the centralized monitor station 32 can centrally monitor the communication path by channel in the optical communication system as a whole.

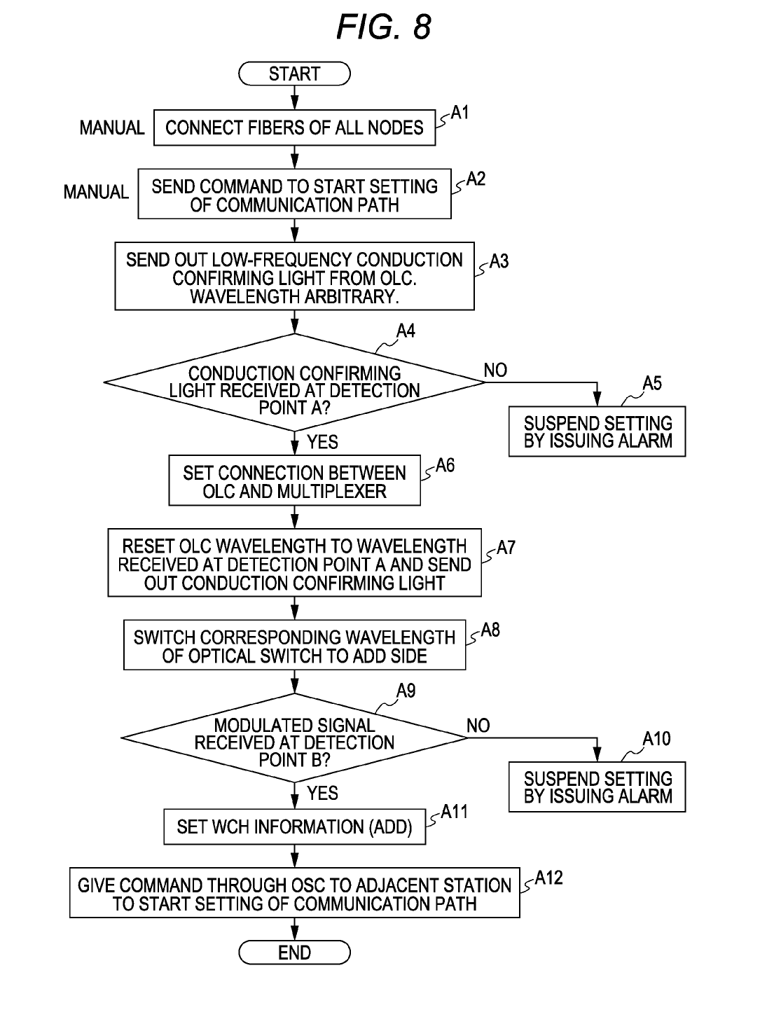

Before starting to set the communication path between the OLCs 20-1 and 20-3, the optical propagation paths (optical fibers) 11 of all the optical propagation apparatuses 10-1 to 10-3 in the optical communication system are connected (operation A1 in FIG. 8).

While the optical propagation apparatuses 10-1 to 10-3 are centrally monitored by the centralized monitor station 32, the communication path is set between, for example, the OLC 20-1 connected under the optical propagation apparatus 10-1 and the OLC 20-3 connected under the optical propagation apparatus 10-3.

The communication path is set, for example, in the manner described below. The conduction confirming light is output from the OLC 20-1, and the conduction of the conduction confirming light is confirmed at a point midway of the communication path to be set between the OLC 20-1 and the OLC 20-3. At the same time, the path following the point where the conduction of the conduction confirming light from the OLC 20-1 is confirmed is set for use as a communication path, while the conduction of the conduction confirming light is confirmed and the path is set sequentially at a plurality of points from the OLC 20-1 to the OLC 20-3 on the other hand.

In order to start to set the communication path as described above, the centralized monitor station 32 transmits a communication path setting start command to the control unit 8 of the optical propagation apparatus 10-1 (operation A2). The optical propagation apparatus 10-1 that has received the command through the control unit 8 sets the communication path in the manner described below (operations A3 to A11).

The control unit 8 of the optical propagation apparatus 10-1 that has received the command outputs a command to the OLC 20-1 underlying the first optical transmission/reception device to output the conduction confirming light for one channel in the wavelength multiplex communication. The OLC 20-1 that has received this command outputs the conduction confirming light from the conduction confirming light transmission unit 21a (operation A3). In the process, the conduction confirming light output from the OLC 20-1 can be the light of any arbitrary channel adapted to be output by the OLC 20-1 regardless of the input port position of the multiplexer 4 to which the OLC 20-1 is connected.

In the optical propagation apparatus 10-1, the conduction confirmation unit 9B (detection point A) of the multiplexer 4 connected to the OLC 20-1 confirms the conduction of the conduction confirming light from the OLC 20-1 (operation A4). Specifically, the conduction confirmation unit 9B, upon detection of the conduction confirming light from the OLC 20-1, outputs the fact to the control unit 8 together with the information on the connection port position at which the particular conduction confirming light is detected (YES in operation A4).

Incidentally, the control unit 8, if not notified that the conduction confirming light is input (conducted) from the conduction confirmation unit 9B upon lapse of a predetermined time-out period, outputs an alarm to the centralized monitor station 32, for example, while at the same time suspending the process of setting the communication path (NO in operation A4 to operation A5).

The control unit 8, upon reception of the information on the detection of the conduction confirming light by the conduction confirmation unit 9B and the connection port position, on the other hand, automatically and without requiring manual input sets the path following the particular conduction point, to be used as a communication path. Specifically, the connection is set between the OLC 20-1 and the multiplexer 4. Thus, the control unit 8 of the first optical propagation apparatus 10-1 is an example of a setting unit for setting the path of the conduction confirming light following the point where the conduction of the conduction confirming light is confirmed by the conduction confirmation unit 9B, to be used as a communication path. In the process, the control unit 8 selects one unoccupied (vacant) channel with reference to the information on the connection setting of the optical switch 5 managed by itself. Specifically, the control unit 8 sets the connection in such a manner that the light of the selected channel is output to the optical switch 5 as the light from the input port of the OLC 20-1 connected with the multiplexer 4 (operation A6).

Further, the control unit 8 resets the wavelength of the conduction confirming light for the OLC 20-1 so that the light of the channel selected as described above is output as the conduction confirming light (operation A7). In the process, the WSS constitutes an element of the multiplexer 4, and therefore, the operator is not required to take the trouble of doing the job of moving the port position of the multiplexer 4 connected with the OLC 20-1 with the resetting of the set channel of the OLC 20-1.

Then, the control unit 8 sets the connection of the optical switch 5 in such a manner that the light along the route from the multiplexer 4 is selectively output as the light of the channel for which the conduction confirming light is output from the OLC 20-1 (operation A8). In the process, the set channel of the conduction confirming light output from the OLC 20-1 is set as a vacant channel, and therefore, the connection setting of the optical switch 5 has no substantial effect on the communication for the channel set to output the light input from the propagation path 11.

Once the connection of the optical switch 5 is set as described above, the conduction confirmation unit 9C (detection point B), arranged on the output side of the WSS 5a constituting the optical switch 5, confirms the conduction of the conduction confirming light from the OLC 20-1 (operation A9). Specifically, the conduction confirmation unit 9C, upon detection of the conduction confirming light from the OLC 20-1, outputs the fact to the control unit 8 together with the information on the channel for which the conduction confirming light is detected (YES in operation A9).

Incidentally, the control unit 8, if not notified that the conduction confirming light is input (conducted) from the conduction confirmation unit 9C upon lapse of a predetermined time-out period, outputs an alarm to the centralized monitor station 32, for example, while at the same time suspending the process of setting the communication path (NO in operation A9 to operation A10).

The control unit 8, upon detection of the conduction confirming light by the conduction light confirmation unit 9C and reception of the information on the particular channel, stores the channel of the particular conduction confirming light as an add (insert) channel in the wavelength multiplex channel setting storage area (operation A11). As a result, the propagation path 11 leading to the optical propagation apparatus 10-2 on the side near the second optical transmission/reception device 20-3, which constitutes the path following the point at which the conduction of the conduction confirming light is confirmed by the conduction confirmation unit 9c, can be set for use as a communication path. Thus, the control unit 8 of the first optical propagation apparatus 10-1 is an example of the setting unit for setting, to use as a communication path, the path of the conduction confirming light following the point where the conduction of the conduction confirming light is confirmed by the conduction confirmation unit 9C.

The conduction confirming light from the OLC 20-1 is amplified by the optical amplifier 1b through the optical switch 5 and the multiplexer 4 for which the connection setting is completed in the optical propagation apparatus 10-1 as described above, and sent out to the optical propagation apparatus 10-2 through the optical propagation path 11. Incidentally, the signal light modulated from the main signal can be sent out as the light of the channels other than the channel for sending out the conduction confirming light.

In the process, the OSC 7 of the optical propagation apparatus 10-1 generates the control information light, and by transmitting the generated control information light to the optical propagation apparatus 10-2, instructs the optical propagation apparatus 10-2 adjacent thereto to start the setting of the communication path (operation A12). Specifically, the optical propagation apparatus 10-1 sends out also the control information light generated in the OSC 7, through the combiner 6b and the optical propagation path 11 to the optical propagation apparatus 10-2. Incidentally, the command information included in the control information light generated by the OSC 7 can include the information on the optical propagation apparatus 10-3 accommodating the optical transmission/reception device 20-3 as an address in addition to the information notifying the channel for sending out the conduction confirming light.

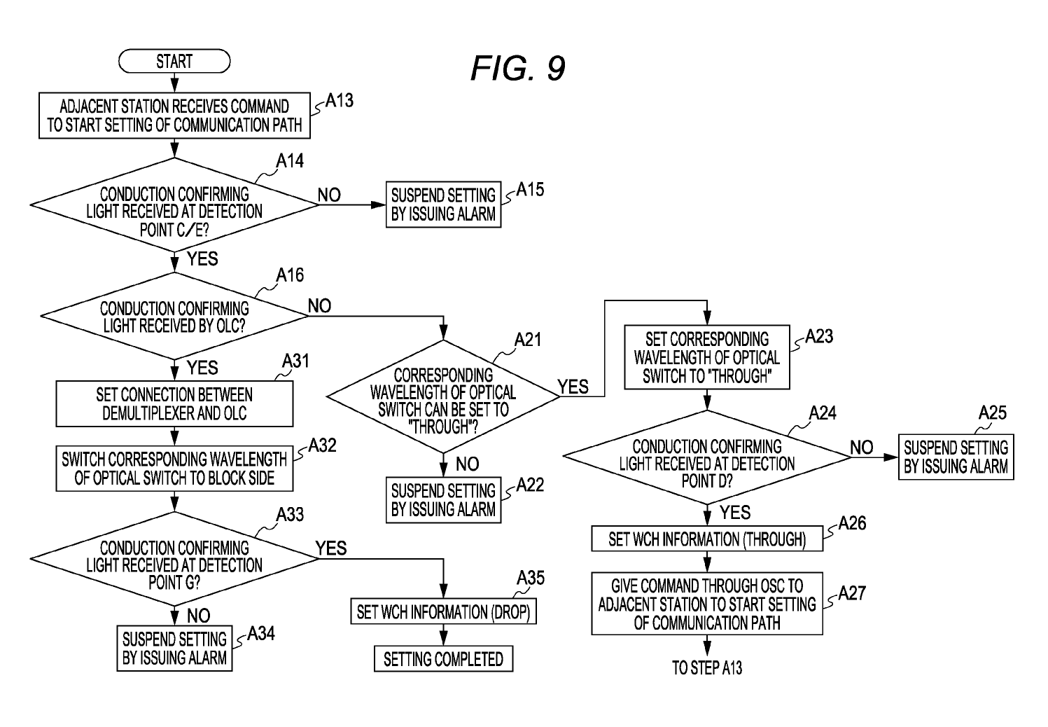

In the optical propagation apparatus 10-2 which receives the conduction confirming light and the control information light from the optical propagation apparatus 10-1, the communication path is set as described below (operations A13 to A16, A21 to A26 in FIG. 9).

Specifically, the OSC unit 7 of the optical propagation apparatus 10-2, upon reception of the control information light from the optical propagation apparatus 10-1 (operation A13), the information for notifying the channel sending out the conduction confirming light is extracted from the received control information light and delivered to the control unit 8. The control unit 8 having received the channel notification information waits for a predetermined time-out period before arrival of a notification from the conduction confirmation unit 9A of the demultiplexer 3 to the effect that the conduction confirming light has been detected from the optical propagation apparatus 10-1.

Specifically, the conduction confirmation unit 9A, upon detection of the conduction confirming light from the optical propagation apparatus 10-1, outputs the fact to the control unit 8 together with the information on the connection port position where the particular conduction confirming light is detected (YES in operation A14). The control unit 8, on the other hand, if not notified that the conduction confirming light is input (conducted) from the conduction confirmation unit 9B upon lapse of a predetermined time-out period, outputs an alarm, for example, to the centralized monitor station 32 while at the same time suspending the process of setting the communication path (NO in operation A14 to A15).

The control unit 8, upon detection of the conduction confirming light by the conduction confirmation unit 9A and reception of the information on the connection port position, judges whether the OLC to which the conduction confirming light is addressed coincides with the OLC connected to the particular connection port position, based on the address information included in the control information light. In the case under consideration, the control unit 8 judges that the OLC is not connected to the connection port position (NO in operation A16).

In this case, the control unit 8 sets the connection of the optical switch 5 in such a manner as to lead the channel of the conduction confirming light toward the optical amplifier 1b (through setting) (YES in operation A21 to operation A23). In the case where the OLC 20-2 (indicated by dotted line) is not accommodated in the optical propagation apparatus 10-2, as illustrated in FIG. 7, the control unit 8 may set the direction of the channel of the optical switch 5 in this way as “through setting”.

Also, in the case where the add setting prevails for the channel of the conduction confirming light and the through setting is impossible in the optical switch 5 of the optical propagation apparatus 10-2, then an alarm is output to the centralized monitor station 32, for example, to suspend the process of setting the communication path (NO in operation A21 to operation A22).

The control unit 8, if the through setting is carried out for the channel of the conduction confirming light of the optical switch 5 as described above, waits the notification of the detection of the conduction confirming light from the conduction confirmation unit 9C for a predetermined time-out period. The conduction confirmation unit 9C is arranged in the last stage of the WSS 5a (FIG. 5) of the optical switch 5 and detects that the conduction confirming light from the optical propagation path 11 has passed through the WSS 5a and reached the output side of the WSS 5a (detection point D).

Specifically, the conduction confirmation unit 9C, upon detection of the conduction confirming light passed through the WSS 5a, outputs the fact to the control unit 8 together with the information on the channel where the particular conduction confirming light is detected (YES in operation A24). On the other hand, the control unit 8, if not notified that the conduction confirming light is input (conducted) from the conduction confirmation unit 9B on upon lapse of a predetermined time-out period, outputs an alarm to the centralized monitor station 32, for example, while at the same time suspending the process of setting the communication path (NO in operation A24 to operation A25).

The control unit 8, upon detection of the conduction confirming light by the conduction confirmation unit 9C and reception of the information on the particular channel, stores the channel of the particular conduction confirming light as a through (pass) channel in the setting storage area of the wavelength multiplex channel (operation A26). As a result, the setting can be carried out to use, as a communication path, the propagation path 11 leading to the optical propagation apparatus 10-3 near the second optical transmission/reception device 20-3 following the point where the conduction of the conduction confirming light is confirmed by the conduction confirmation unit 9C. Thus, the control unit 8 of the optical propagation apparatus 10-2 is an example of the setting unit for setting, as a communication, the path of the conduction confirming light following the point where the conduction of the conduction confirming light is confirmed by the conduction confirmation unit 9C.

Also, the conduction confirming light from the OLC 20-1 is sent out to the optical propagation apparatus 10-2 through the optical propagation path 11 and the optical propagation apparatuses 10-1, 10-2 in which the connection setting is completed as described above.

In the process, the OSC 7 of the optical propagation apparatus 10-2 generates the control information light and sends out the generated control information light to the optical propagation apparatus 10-3, thereby instructing the optical propagation apparatus 10-3 adjacent thereto to start setting a communication path (operation A27). Specifically, in the optical propagation apparatus 10-1, the control information light generated by the OSC 7 is also sent out to the optical propagation apparatus 10-3 through the combiner 6b and the optical propagation path 11. The command information included in the control information light generated in the OSC 7, like the control information light generated by the OSC 7 of the optical propagation apparatus 10-1, can contain not only the information for notifying the channel for transmission of the conduction confirming light but also the information on the optical propagation apparatus 10-3 accommodating the optical transmission/reception device 20-3 as an address.

Incidentally, in the case illustrated in FIG. 7, only one optical propagation apparatus 10-2 is used for relaying the channel of the communication path to be set. However, two or more optical propagation apparatuses 10-2 can alternatively be used. In such a case, each optical propagation apparatus for relay sequentially executes the process (operations A13 to A16, A21 to A27 in FIG. 9) for setting the communication path described above while at the same time propagating the conduction confirming light.

In the optical propagation apparatus 10-3 which receives the conduction confirming light and the control information light from the optical propagation apparatus 10-2, the communication path is set as described below (operations A13 to A16, A31 to A35 in FIG. 9).

Specifically, the OSC unit 7 of the optical propagation apparatus 10-3, upon reception of the control information light from the optical propagation apparatus 10-2 (operation A13), extracts from the received control information light the information notifying the channel for sending out the conduction confirming light and delivers it to the control unit 8. The control unit 8 that has received this channel notification information waits the arrival, for a predetermined time-out period from the conduction confirming unit 9A in the demultiplexer 3, of the notification that the conduction confirming light from the optical propagation apparatus 10-2 is detected.

Specifically, the conduction confirmation unit 9A, upon detection of the conduction confirming light from the optical propagation apparatus 10-2, outputs the fact to the control unit 8 together with the information on the connection port position where the particular conduction confirming light is detected (YES in operation A14). On the other hand, the control unit 8, if not notified that the conduction confirming light is input (conducted) from the conduction confirmation unit 9B upon lapse of the predetermined time-out period, outputs an alarm to the centralized monitor station 32, for example, while at the same time suspending the process of setting the communication path (NO in operation A14 to operation A15).

The control unit 8, upon detection of the conduction confirming light by the conduction confirmation unit 9A and reception of the information on the connection port position, judges whether the OLC to which the conduction confirming light is addressed is connected to the connection port position, based on the address information contained in the control information light. In the case under consideration, the judgment is that the particular OLC is connected to the connection port position (YES in operation A16).

In this case, the control unit 8 sets the operation of the demultiplexer 3 in such a manner as to guide the channel of the conduction confirming light to the underlying OLC 20-3. Further, the connection of the optical switch 5 is set in such a manner as not to be guided toward the optical amplifier 1b (block setting) (YES in operation A21 to operation 23). Incidentally, the optical switch 5 may alternatively be set (add setting) in such a manner that the light from the multiplexer 4 not shown is guided to the optical amplifier 1b. As a result, the conduction confirming light is prevented from being passed outside the communication path.

Thus, the control unit 8 of the second optical propagation apparatus 10-3 is an example of the setting unit for the setting operation whereby the path of the conduction confirming light following the point where the conduction of the conduction confirming light is confirmed by the conduction confirmation unit 9A is used as a communication path.

In the case where the channel block of the conduction confirming light is set for the optical switch 5 by the control unit 8, the control unit 8 then waits for a predetermined time-out period until the arrival of the notification from the conduction confirming light receiving unit 21b of the OLC 20-3 constituting an address of the reception of the conduction confirming light that the reception of the conduction confirming light is confirmed.

Specifically, the conduction confirming light receiving unit 21b, upon reception of the conduction confirming light passed through the demultiplexer 3, outputs the notification for confirming the reception thereof (reception confirming notification) to the control unit 8 (YES in operation A33). In the case where the reception confirming notification from the conduction confirming light receiving unit 21b fails to arrive upon lapse of the predetermined time-out period, on the other hand, the control unit 8 outputs an alarm to the centralized monitor station 32, for example, while at the same time suspending the process of setting the communication path (NO in operation A33 to operation A34).

The control 8, upon reception of the reception confirming notification from the conduction confirming light receiving unit 21b, stores a channel of the particular conduction confirming light as a drop (divergence) channel in the set storage area of the wavelength multiplex channel (operation A35). The setting of the communication path can thus be completed.

Incidentally, each of the optical propagation apparatuses 10-1 to 10-3 may reconfirm a conduction confirmation result through the conduction confirmation units 9A to 9C which confirm the conduction (transmission) of the conduction confirmation light and thereby may confirm whether a signal path is incorrect or not. As another alternative, the centralized monitor station 32, for example, may confirm that no alarm is generated from the control unit 8 in all the optical propagation apparatuses 10-1 to 10-3 through which the signal is passed.

As described above, according to this embodiment, automation of setting of the communication path can be promoted where manual input of a path is not required.

Further, the time required for the setting can be shortened.

Also, the work load can be reduced and a setting error or the like suppressed.

In the embodiment described above, the conduction of the conduction confirming light is confirmed at a plurality of points in the first optical propagation apparatus 10-1 and the second optical propagation apparatus 10-3, and the setting operation is performed whereby the path following the point where the conduction is confirmed is used as a communication path. As an alternative, the conduction of the conduction confirming light is confirmed at one or more points midway of the communication path to be set in the first optical transmission/reception device 10-1 and the second optical transmission/reception device 10-3 on the one hand, and the setting operation may be performed whereby the path following the point where the conduction is confirmed is used as a communication path on the other hand.

The aforementioned embodiment, though illustrated as a communication system for wavelength multiplex communication, is applicable as a combination with the polarization multiplexing, for example, or applicable to a system for performing other multiplex communication.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions has (have) been described in detail, it should be understood that the various changes, substitutions, and alterations could be made hereto without departing from the spirit and scope of the invention, the scope of which is defined in the claims and their equivalents.

What is claimed is:

1. A method of setting a communication path to propagate a signal light between first and second optical transmission/reception devices accommodated in first and second optical propagation apparatuses, respectively, each connected to a propagation path for multiplex communication, through the first and second optical propagation apparatuses and the propagation path, comprising:
outputting, using the first optical transmission/reception device, a conduction confirming light to the first optical propagation apparatus in one channel for the multiplex communication;
confirming a conduction confirming light at a point midway of the communication path to be set between the first and second optical transmission/reception devices, and setting a path following the point where the conduction of the conduction confirming light from the first optical transmission/reception device is confirmed for use as the communication path; and
sequentially setting the communication path at a plurality of points from the first optical transmission/reception device to the second optical transmission/reception device.

2. The communication path setting method according to claim 1,
wherein the first optical propagation apparatus is such that:
the conduction confirming light is confirmed and the communication path is set at one or more points between a connection point of the first optical transmission/reception device and the first optical propagation apparatus and a connection point of the propagation path and the first optical propagation apparatus, based on the conduction confirming light input from the optical propagation apparatus; and
the conduction confirming light input from the first optical transmission/reception device through the path set for use as the communication path is sent out to the propagation path together with control information light notifying channel information of the conduction confirming light; and
wherein the second optical propagation apparatus is such that:
the conduction confirming light and the control information light are input from the propagation path;
the conduction confirming light is confirmed and the communication path is set at one or more points between a connection point of the propagation path and second optical propagation apparatus and a connection point of the second propagation apparatus and the second optical transmission/reception device, based on the conduction confirming light and the control information light input; and
the setting of the communication path is completed after the second transmission/reception device confirms the conduction confirming light through the propagation path and the second propagation apparatus.

3. The communication path setting method according to claim 2,
wherein a third optical propagation apparatus interposed in the propagation path connecting the first and second optical propagation apparatus is input with the conduction confirming light and the control information light,
the conduction confirming light is confirmed and the communication path is set based on the conduction confirming light and the control information light thus input, and
the control information light together with the conduction confirming light is sent out to a propagation path near the second optical propagation apparatus.

4. The communication path setting method according to claim 1,
wherein the conduction confirming light is a low-frequency modulated light modulated at a lower frequency than a frequency corresponding to a bit rate of a main signal.

5. The communication path setting method according to claim 1,
wherein the setting of the path includes setting of a channel used by the signal light and setting of a connection of elements in the apparatus whereby a path up to the point of conduction confirmation is used as the communication path in each optical propagation apparatus.

6. A communication system to set a communication path to propagate a signal light through a propagation path for multiplex communication between first and second optical transmission/reception devices accommodated in first and second optical propagation apparatuses, respectively, and through the first and second optical propagation apparatuses, comprising:
the first optical transmission/reception device including:
a conduction light transmission unit to transmit, to the second optical transmission/reception device, a conduction confirming light in one channel of multiplex communication through the first optical propagation apparatus, the propagation path and the second optical propagation apparatus; and
the first and second optical propagation apparatuses each including:
a conduction confirmation unit to confirm the conduction confirming light at a point of the path set as the communication path in each optical propagation apparatus, and
a setting unit to use, as the communication path, a path of the conduction confirming light following a point where the conduction confirming light is confirmed by the conduction confirmation unit.

7. The communication system according to claim 6, comprising:
a third optical propagation apparatus interposed in the propagation path between the first and second optical propagation apparatuses, and
wherein the third optical propagation apparatus includes the conduction confirmation unit and the setting unit.

8. An optical propagation apparatus arranged in relation to a communication system to set a communication path to propagate a signal light between optical transmission/reception devices in different optical propagation apparatuses, through a propagation path for multiplex communication and the optical propagation apparatuses accommodating each optical transmission/reception device, the optical propagation apparatus comprising:
a conduction confirmation unit to confirm a conduction confirming light output from one of the optical transmission/reception devices; and
a setting unit to set, as a part of the communication path, the propagation path of the conduction confirming light following a point where the conduction confirming light is confirmed by the conduction confirmation unit.

9. The optical propagation apparatus according to claim 8, comprising:
a demultiplexer to separate a light input from the propagation path into a light for each channel in multiplex communication;
a multiplexer to multiplex the light from the optical transmission/reception device for each channel in the multiplex communication; and
an optical switch to selectively output, in an optical unit of each channel, selected one of the light input from the propagation path and the light from the multiplexer.

10. The optical propagation apparatus according to claim 9,
wherein the conduction confirmation unit includes a first conduction confirmation unit arranged on an output side of the optical switch to confirm the conduction confirming light for each channel.

11. The optical propagation apparatus according to claim 9,
wherein the conduction confirmation unit includes a second conduction confirmation unit arranged on a path of the light demultiplexed in wavelength by the demultiplexer to confirm the conduction confirming light for each channel.

12. The optical propagation apparatus according to claim 9,
wherein the conduction confirmation unit includes a third conduction confirmation unit arranged on a path of the light multiplexed by the multiplexer to confirm the conduction confirming light for each channel.
